(19) United States
(12) Patent Application Publication
(10) Pub. No.: US 2009/0185337 A1
(43) Pub. Date: Jul. 23, 2009

(54) PITCH BOX ASSEMBLY

(76) Inventor: Richard A. Marshall, St. Louis, MO (US)

Correspondence Address: THE SMALL PATENT LAW GROUP LLP, 225 S. MERAMEC, STE. 725T, ST. LOUIS, MO, 63105, US

(21) Appl. No.: 12/018,636

(22) Filed: Jan. 23, 2008

(51) Int. Cl. H02G 3/08

(52) U.S. Cl. 361/673

(57) ABSTRACT

A pitch box assembly for a rooftop application includes a plurality of line sets penetrating through the rooftop, wherein the line sets are configured for supplying a cooling circuit for condenser units, and a plurality of electrical lines penetrating through the rooftop, wherein the electrical lines are configured for supplying power to the condenser units. The pitch box assembly also includes a base mounted to the rooftop, wherein the base has an interior channel receiving the line sets and the electrical lines, and a pitch box mounted to the base. The pitch box has a plurality of disconnects for controlling the supply of power to each of the condenser units. The electrical lines are routed into the pitch box and terminated to respective ones of the disconnects.

### BACKGROUND OF THE INVENTION

The subject matter herein relates generally to pitch box assemblies, and more particularly, to pitch box assemblies for split system HVAC units or other roof top applications.

Some commercial and residential buildings typically provide components or appliances on the rooftops thereof, such as, for example, HVAC units, satellites, communication towers, pumps and the like. The rooftop mounted components or appliances typically require interconnection with corresponding internal components. In the example of the HVAC unit, a line set, having refrigerant lines and a thermostat line, and electrical power lines are needed to operate the HVAC unit. Each of these lines must penetrate through the roof to interconnect the internal and external components. Other line types ma be needed for other applications, such as communication lines, cables, gas lines, fluid lines, and the like.

A common method of providing a roof penetration is with a pitch box, which is a box installed around the lines penetrating the roof filled with tar. However, because each of the different lines are typically installed by a different installer, such as an HVAC technician and an electrician, each line penetrates the roof at a different location, such as at a location that is most convenient for the particular line type and/or for the particular installer. The lines are then run to the appropriate area of the roof, such as the HVAC unit. While this method may be convenient for the installer, the building owner is typically frustrated with the number and/or position of line penetrations scattered about the roof. Additionally, each additional penetration is an additional potential area for maintenance and/or weather damage over time. For example, the pitch box may not be properly sealed, which may lead to leakage and the like.

In addition to installation and maintenance considerations, building codes affect construction of and connection to various rooftop mounted components. For example, for each of the HVAC units, local building codes or other applicable regulations typically require a rated NEMA disconnect in the vicinity of the HVAC unit. The disconnect is basically an electrical switch which cuts power to the HVAC unit when it is to be serviced. Local building codes may also require service power for a service technician to be located in the vicinity of the rooftop mounted component. The service power is typically another electrical line that is routed to the area, which is again another rooftop penetration.

Accordingly, a need exists for a device that provides fewer penetrations through the roof for rooftop mounted components. A need also exists for a device that may reduce the installation, service and/or maintenance time and cost for rooftop mounted applications.

### BRIEF DESCRIPTION OF THE INVENTION

In one embodiment, a pitch box assembly is provided for a rooftop application. The pitch box assembly includes a plurality of line sets penetrating through the rooftop, wherein the line sets are configured for supplying a cooling circuit for condenser units, and a plurality of electrical lines penetrating through the rooftop, wherein the electrical lines are configured for supplying power to the condenser units. The pitch box assembly also includes a base mounted to the rooftop, wherein the base has an interior channel receiving the line sets and the electrical lines, and a pitch box mounted to the base. The pitch box has a plurality of disconnects for controlling the supply of power to each of the condenser units. The electrical lines are routed into the pitch box and terminated to respective ones of the disconnects.

Optionally, the pitch box assembly may also include a ground-fault circuit interrupter outlet accessible from the exterior of the pitch box, wherein one of the electrical lines powers the ground fault circuit interrupter outlet. The pitch box may include threaded connectors on an exterior of the pitch box, wherein the threaded connectors are each configured to receive a liquid-tight flexible conduit. The electrical lines are configured to be routed to the condensing units through the conduits. Optionally, the line sets and the electrical lines penetrate through a single opening in the rooftop, and the base is aligned with the opening in the rooftop for receiving the line sets and the electrical lines. The disconnects may define horse power rated switches, that may be accessible from the exterior of the pitch box for switching between power on states and power off states. Optionally, the pitch box may be hingedly coupled to the base.

In another embodiment, a pitch box assembly is provided for organizing a plurality of line sets and a plurality of electrical lines for operating rooftop condenser units, wherein the line sets and the electrical lines penetrate the rooftop in the same vicinity as one another. The pitch box assembly includes a base mounted to the rooftop in the vicinity of the penetration of the line sets and the electrical lines. The base has an interior channel and a divider received within the channel, wherein the divider divides the channel into a first well and a second well. The first well receives line sets and the second well receives electrical lines. A pitch box is mounted to the base, wherein the pitch box has a chamber for receiving the electrical lines from the second well.

Optionally, the divider may isolate the line sets from the electrical lines. The base may include an open bottom that is aligned with an opening in the rooftop, wherein the line sets and the electrical lines extend through the opening in the rooftop into the respective wells of the base. Optionally, the pitch box may include a plurality of dividing walls defining a plurality of compartments, wherein the compartments each receive one of the electrical lines and the compartments each have either an outlet or a switch associated therewith to which the corresponding electrical line is terminated.

In a further embodiment, a system for operating a rooftop HVAC condenser unit is provided that includes a base mounted to the rooftop, wherein the base has at least one wall that defines an interior channel and an opening in the wall. A pitch box is mounted to the base, wherein the pitch box has a disconnect for controlling the supply of power to the condenser unit, and the pitch box has a threaded connector. A line set penetrates through the rooftop into the channel. The line set extends through the opening in the wall to the condenser unit for supplying a cooling circuit for the condenser unit. A first electrical line penetrates through the rooftop into the channel and the first electrical line is directed into the pitch box and terminated to the disconnect. A second electrical line is connected to the condenser unit and is housed within a liquid tight flexible conduit. The liquid tight flexible conduit is connected to the threaded connector on the pitch box such that the first and second electrical lines may be connected to one another within the pitch box to supply power to the condenser unit.

### BRIEF DESCRIPTION OF THE DRAWINGS

FIG. 1 schematically illustrates a system for operating split system HVAC condenser units in accordance with an exemplary embodiment.

FIG. 2 is a front view of an exemplary pitch box assembly for the system shown in FIG. 1.

FIG. 3 is a side view of the pitch box assembly shown in FIG. 2.

FIG. 4 is a rear view of the pitch box assembly shown in FIGS. 2 and 3.

FIG. 5 is a top plan view of the pitch box assembly.

FIG. 6 is a top plan view of an alternative pitch box assembly formed in accordance with an alternative embodiment.

FIG. 7 is a side cross-sectional view of another alternative pitch box assembly formed in accordance with another alternative embodiment.

### DETAILED DESCRIPTION OF THE INVENTION

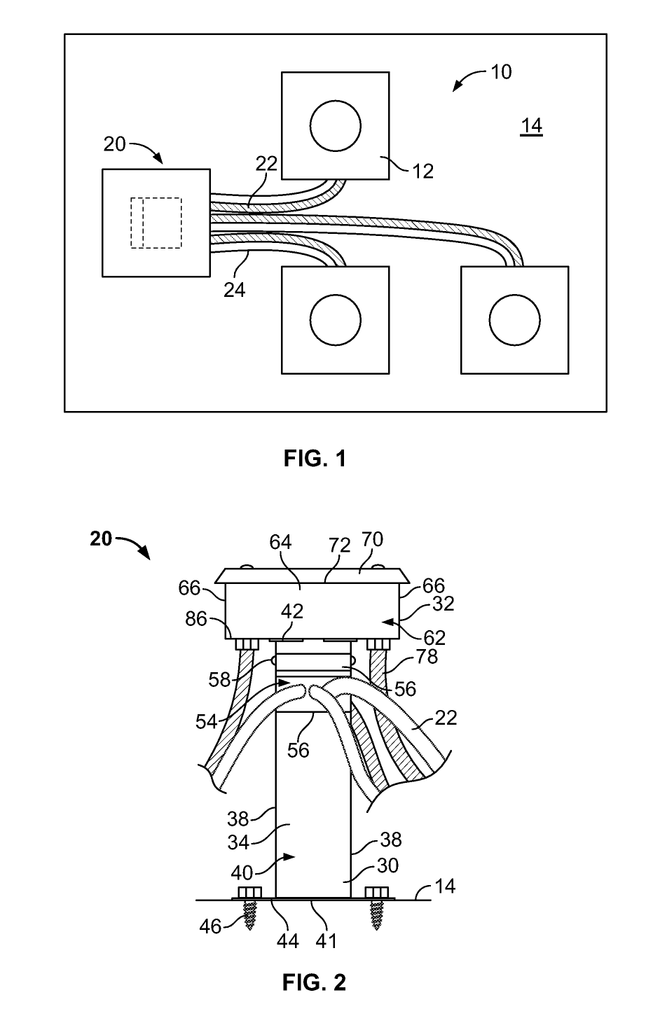

FIG. 1 schematically illustrates a system 10 for operating split system HVAC condenser units 12 in accordance with an exemplary embodiment. The condenser units 12 are arranged on a rooftop 14 of a building and define an external component of the heating and cooling system for the building. While the embodiments illustrated and described herein relate to split system HVAC condenser units 12, the subject matter has applicability to other applications other than such condenser units 12, such as satellites, communication towers, pumps or other rooftop mounted components or appliances that utilize some means of interconnection with corresponding internal components. More particularly, the subject matter has applicability to components that have lines that penetrate through the rooftop to interconnect an internal component with an external component, such as power lines, communication lines, cables, refrigerant lines, gas lines, fluid lines, and the like. As such, the condenser units 12 are shown for illustrative purposes, and the subject matter herein is not limited to such an application. Additionally, while three condenser units 12 are shown, it is realized that the system 10 may include any number of condenser units 12.

The system 10 includes a pitch box assembly 20 that is used to organize line sets 22 and electrical lines 24 for the individual condenser units 12. Again, in alternative embodiments, other types of lines may be provided and organized by the pitch box assembly 20 other than line sets or electrical lines, depending on the particular application and externally mounted component. The line sets 22 include refrigerant lines and a thermostat wire that forms a cooling circuit for the condenser units 12. The electrical lines 24 are used to supply power to the condenser units 12. In an exemplary embodiment, the line sets 22 and the electrical lines 24 penetrate through a common opening 26 through the rooftop 14. In alternative embodiments, multiple openings 26 may be provided within the same vicinity, such as within an envelope defined by the pitch box assembly 20. For example, the line sets 22 may penetrate through a first opening and the electrical lines 24 may penetrate through a second opening proximate to the first opening. By organizing the line sets 22 and the electrical lines 24 within a common housing, namely the pitch box assembly 20, the occupied space of the rooftop 14 may be minimized.

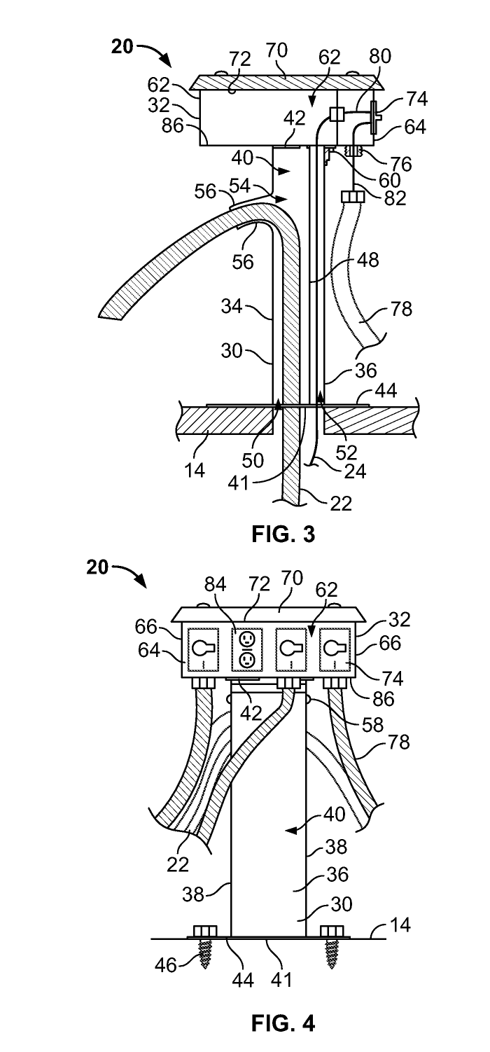

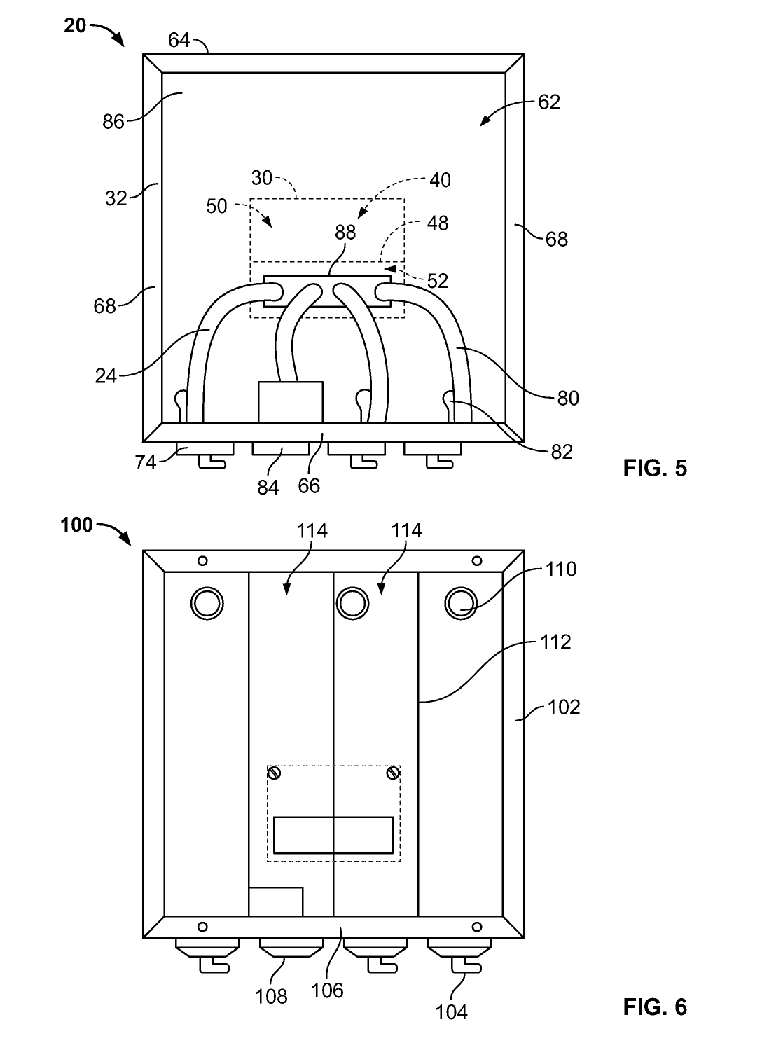

FIG. 2 is a front view of an exemplary pitch box assembly 20 for the system 10 (shown in FIG. 1). FIG. 3 is a side cross-sectional view of the pitch box assembly 20. FIG. 4 is a rear view of the pitch box assembly 20. FIG. 5 is a top plan view of the pitch box assembly 20. Exemplary components and operations of the pitch box assembly 20 are described with reference to FIGS. 2-5.

The pitch box assembly 20 includes a stack or base 30 mounted to the rooftop 14 and a pitch box 32 mounted to the base 30. In an exemplary embodiment, the base 30 is rectangular and includes a plurality of walls that define a front wall 34, a rear wall 36 and side walls 38. The base 30 may be fabricated from a plastic or metal material, such as 16 gauge steel. Optionally, the base material may be any material that is NEMA 3R compliant. The base 30 has a height selected to elevate the pitch box assembly 20 off of the rooftop 14, such as to a height that is easily accessible and/or convenient for a service technician or installer to utilize. It is realized that the base 30 may have any size and shape depending on the particular application. The walls 34, 36, 38 define a generally hollow interior channel 40 that extends between a bottom 41 and a top 42 of the base 30. The bottom 41 and top 42 are open such that the line sets 22 and/or the electrical lines 24 may be pulled therethrough. In an exemplary embodiment, a mounting flange 44 is provided at the bottom 41 for mounting to the rooftop 14 using fasteners 46. Other mounting methods and means may be utilized in alternative embodiments. In some alternative embodiments, the base 30 may extend at least partially through the opening 26 (shown in FIG. 3) in the rooftop 14.

When assembled, the base 30 is substantially aligned with the opening 26 and the line sets 22 and electrical lines 24 extend into the interior channel 40. In an exemplary embodiment, as shown in FIG. 3, a divider 48 is provided within the interior channel 40 to divide the interior channel 40 into a first well 50 and a second well 52. The line sets 22 extend into the first well 50 and the electrical lines 24 extend into the second well 52. The divider 48 isolates the line sets 22 from the electrical lines 24. Optionally, additional dividers and wells may be utilized in alternative embodiments. Additionally, in other alternative embodiments, the dividers 48 may be utilized to isolate a line set 24 and an associated electrical line 24 from a different group of line sets 22 and electrical lines 24, wherein the groups may be divided based on different apartments, offices or floors of the building. Optionally, the first and/or second well 50, 52 may be at least partially filled with a filler material, such as a foam material or a tar material. The filler material may provide insulation and/or weatherproofing.

The base 30 includes a slot or aperture 54 formed in the front wall 34, however an additional wall or a different wall may include the aperture 54 in alternative embodiments. The aperture 54 is sized, shaped and positioned to allow the line sets 22 to pass from the first well 50 to the exterior of the base 30. The line sets 22 may then be routed to the respective condenser unit 12 (shown in FIG. 1). In an exemplary embodiment, a lip 56 is provided at the bottom of the aperture 54 for guiding and/or supporting the line sets 22 as the line sets 22 transition from the first well 50 to the exterior of the base 30. Optionally, the lip 56 may be curved to provide a smooth transition to resist damage to the line sets 22, such as from cutting or creasing the line sets 22. In an exemplary embodiment, the lip 54 defines the upper-most portion of the front wall 34 such that a desired length of the line sets 22 may be pulled through the first well 50 and draped over the lip 54. The lip 54 may be integrally formed with the front wall 34 or the lip 54 may be coupled to the front wall 34. In an exemplary embodiment, a hood 56 is provided at the top of the aperture 54 for weather protection and/or for holding the line sets 22 in position within respect to the aperture 54. Optionally, the hood 56 may be removable from the base 30, such as by coupling the hood 56 to the side walls 38 of the base 30 using fasteners 58 (shown in FIGS. 2 and 4).

The pitch box 32 is mounted to the base 30. In an exemplary embodiment, as illustrated in FIG. 3, the pitch box 32 is hingedly mounted to the base 30 by a hinge 60 at the rear wall 36 of the base 30. The hinged coupling allows the pitch box 34 to be rotated upward, which provides access to the interior channel 40 of the base 30 for pulling the lines sets 22 and/or the electrical lines 24 through the base 30. Other mounting methods and means may be utilized in alternative embodiments.

The pitch box 32 is generally box shaped and includes a plurality of walls that define a chamber 62, more particularly, a front wall 64, rear wall 66 and side walls 68 define the chamber 62. The pitch box 32 is oversized with respect to the base 30 to provide cover and/or protection from the weather for the base 30. The pitch box 32 may be fabricated from a plastic or metal material, such as 16 gauge steel. Optionally, the pitch box material may be any material that is NEMA 3R compliant. It is realized that the pitch box 32 may have any size and shape depending on the particular application. A cover 70 is attached to a top 72 of the pitch box 32 to protect the pitch box 32 from rain or from tampering by unauthorized people. FIG. 5 illustrates the chamber 62 with the cover 70 removed.

The pitch box 32 includes a plurality of disconnects 74, shown in FIGS. 3, 4 and 5, for controlling the supply of power to each of the condenser units 12 (shown in FIG. 1). The disconnects 74 are electrically connected with a corresponding one of the electrical lines 24, as shown in FIGS. 3 and 5. The disconnects 74 are also electrically connected to an associated one of the condenser units 12. In an exemplary embodiment, the disconnects 74 represent switches, such as horse power rated switches, and may be referred to hereinafter as switches 74. The switches 74 are accessible from the exterior of the pitch box 32. Optionally, the switches 74 may include a weatherproof cover. An operator may operate the switch 74 by switching between a power on state, in which power is supplied to the associated condenser unit 12, and a power off state, in which power is shut off from the associated condenser unit 12. As such, when the condenser unit 12 is being serviced by a technician, the technician is able to disconnect power from the condenser unit 12 by operating the switch 74.

As illustrated in FIG. 3, the pitch box 32 includes a plurality of externally located connectors 76 that have an opening therethrough. Liquid-tight flexible conduits 78 are coupled to the connectors 76. Optionally, the connectors 76 are male threaded connectors and the conduits 78 are female threaded for facilitating the connection. Other types of connections may be utilized in alternative embodiments.

In an exemplary embodiment, as illustrated in FIG. 3, the electrical line 24 extends from the interior of the building, through the base 30 and is electrically connected to the disconnect 74. The electrical line 24 represents a first electrical line 80. A second electrical line 82 is provided within the flexible conduit 78 and is terminated at one end to the disconnect 74, and at the other end to the condenser unit 12. The flexible conduit 78 protects the second electrical line 82. Power is supplied from the first electrical line 80 to the second electrical line 82 via the switch 74, when the switch 74 is in the on state. Optionally, the first and second electrical lines 82 may be interconnected by alternative methods and means.

The pitch box 32 also includes at least one ground-fault circuit interrupter (GFCI) outlet 84 (shown in FIGS. 4 and 5). The outlet 84 is accessible from the exterior of the pitch box 32. The outlet 84 provides a source of power for a technician working on one of the condenser units 12, such as for tools that may be required during service. As shown in FIG. 5, one of the electrical lines 24 is terminated to the outlet 84 to supply power to the outlet 84. Optionally, the outlet 84 may include a weatherproof cover.

FIG. 5 also illustrates a bottom 86 of the pitch box 32. A slot 88 is formed in the bottom 86 and is aligned with the second well 52 such that the electrical lines 24 may be pulled into the chamber 62. The electrical lines 24 are then terminated to either the switches 74 or the outlet 84. In the illustrated embodiment, each of the switches 74 and the outlet 84 are positioned along the rear wall 66 of the pitch box 32. However, the switches 74 and/or the outlet 84 may be positioned on a different wall or different walls.

FIG. 6 is a top plan view of an alternative pitch box assembly 100 formed in accordance with an alternative embodiment. The pitch box assembly 100 includes a pitch box 102 that is similar to the pitch box 32 in some respects. The pitch box 102 includes disconnects 104 along one of the walls 106, as well as a GFCI outlet 108. The pitch box 102 also includes connectors 110, similar to the connector 76, however the connectors 110 are positioned at an end of the pitch box 102 opposite from the disconnects 104.

The pitch box 102 includes a plurality of dividing walls 112 that divide the chamber into compartments 114. Each compartment 114 includes one of the disconnects 104 and one of the connectors 110. Electrical lines (not shown) are pulled into the compartments 114 of the pitch box 102 and run to the disconnect 104 and the connectors 110. As such, each circuit is isolated from each other circuit by the dividing walls 112.

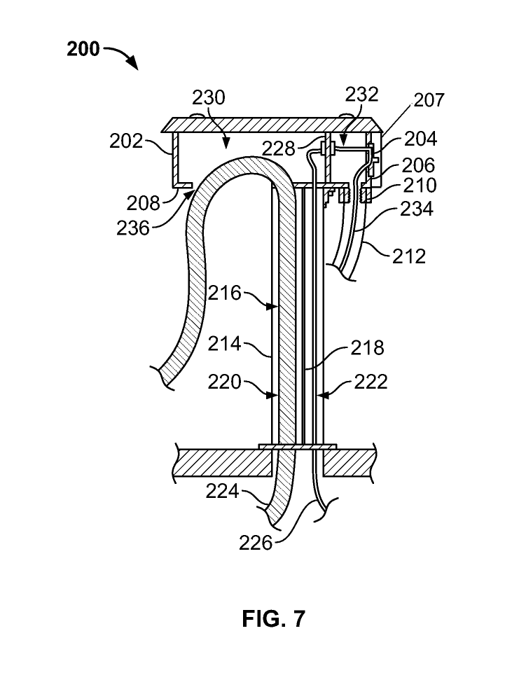

FIG. 7 is a side cross-sectional view of another alternative pitch box assembly 200 formed in accordance with another alternative embodiment. The pitch box assembly 200 includes a pitch box 202 that is similar to the pitch box 32 in some respects. The pitch box 202 includes a disconnect 204 along one of the walls 206. Optionally, a cover 207 may cover the disconnect 204 from tampering or from the environment. The cover 207 may be lockable. The pitch box 202 also includes a bottom 208 that has a connector 210, similar to the connector 76, extending therefrom. A liquid-tight flexible conduit 212 is connected to the connector 210.

The pitch box 202 is mounted to a base 214 that has an interior channel 216. A divider 218 divides the channel 216 into a first well 220 and a second well 222. A line set 224 extends into the first well 220 and a first electrical line 226 extends into the second well 222. The divider 218 isolates the line set 224 from the electrical line 226. Both the line set 224 and the first electrical line 226 extend into the pitch box 202. A dividing wall 228 is positioned within the pitch box 202. The dividing wall 228 divides the pitch box 202 into a first compartment 230 and a second compartment 232. The second compartment 232 may represent a junction box in which the first electrical line 226 may be terminated. Other dividing walls may be provided that isolates the line set 224 from the first electrical line 226. A second electrical line 234 is terminated to the disconnect 204 within the junction box defined by the second compartment 232 and extends into the conduit 212 to a condenser unit (not shown). The line set 224 extends into the first compartment 230 from the base 214 and is then routed through an aperture 236 in the pitch box 202 to the exterior of the pitch box 202. The line set 224 is then routed to the condenser unit from the pitch box 202.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

What is claimed is:

1. A pitch box assembly for a rooftop application, the pitch box assembly comprising:
a plurality of line sets penetrating through the rooftop, the line sets being configured for supplying a cooling circuit for condenser units;
a plurality of electrical lines penetrating through the rooftop, the electrical lines being configured for supplying power to the condenser units;
a base mounted to the rooftop, the base having an interior channel receiving the line sets and the electrical lines; and
a pitch box mounted to the base, the pitch box having a plurality of disconnects for controlling the supply of power to each of the condenser units, the electrical lines being routed into the pitch box and terminated to respective ones of the disconnects.

2. The pitch box assembly of claim 1, further comprising a ground-fault circuit interrupter outlet accessible from the exterior of the pitch box, one of the electrical lines powering the ground fault circuit interrupter outlet.

3. The pitch box assembly of claim 1, further comprising threaded connectors on an exterior of the pitch box, wherein the threaded connectors are each configured to receive a liquid-tight flexible conduit, and the electrical lines are configured to be routed to the condensing units through the conduits.

4. The pitch box assembly of claim 1, wherein the line sets and the electrical lines penetrate through a single opening in the rooftop, the base being aligned with the opening in the rooftop.

5. The pitch box assembly of claim 1, wherein the disconnects define horse power rated switches.

6. The pitch box assembly of claim 1, wherein the disconnects define switches accessible from the exterior of the pitch box for switching between power on states and power off states.

7. The pitch box assembly of claim 1, wherein the pitch box is hingedly coupled to the base.

8. The pitch box assembly of claim 1, wherein the base includes an aperture in a side wall of the base, the line sets being directed through the aperture to the exterior of the base for connection with respective ones of the condensing units.

9. The pitch box assembly of claim 1, wherein the pitch box is fabricated from a weatherproof material, and wherein at least one of the base and the pitch box are configured to receive a weatherproof foam.

10. The pitch box assembly of claim 1, wherein the pitch box includes a bottom and a plurality of side walls defining a chamber that opens to the channel of the base, the disconnects being arranged along at least one of the side walls.

11. A pitch box assembly for organizing a plurality of line sets and a plurality of electrical lines for operating rooftop condenser units, wherein the line sets and the electrical lines penetrate the rooftop in the same vicinity as one another, the pitch box assembly comprising:
a base mounted to the rooftop in the vicinity of the penetration of the line sets and the electrical lines, the base having an interior channel and a divider received within the channel, the divider dividing the channel into a first well and a second well, the first well receiving line sets and the second well receiving electrical lines; and
a pitch box mounted to the base, the pitch box having a chamber for receiving the electrical lines from the second well.

12. The pitch box assembly of claim 11, wherein the pitch box includes a plurality of disconnects for controlling the supply of power to each of the condenser units, the electrical lines being routed into the chamber and terminated to respective ones of the disconnects.

13. The pitch box assembly of claim 11, wherein the divider isolates the line sets from the electrical lines.

14. The pitch box assembly of claim 11, wherein the base includes an open bottom that is aligned with an opening in the rooftop, the line sets and the electrical lines extending through the opening in the rooftop into the respective wells of the base.

15. The pitch box assembly of claim 11, wherein the pitch box includes a plurality of dividing walls defining a plurality of compartments, the compartments each receive one of the electrical lines and the compartments each have either an outlet or a switch associated therewith to which the corresponding electrical line is terminated.

16. The pitch box assembly of claim 11, further comprising a ground-fault circuit interrupter outlet accessible from the exterior of the pitch box, one of the electrical lines powering the ground fault circuit interrupter outlet.

17. The pitch box assembly of claim 11, further comprising threaded connectors on an exterior of the pitch box, wherein the threaded connectors are each configured to receive a liquid-tight flexible conduit, and the electrical lines are configured to be routed to the condensing units through the conduits.

18. A system for operating a rooftop HVAC condenser unit, the system comprising:
a base mounted to the rooftop, the base having at least one wall that defines an interior channel and an opening in the at least one wall;
a pitch box mounted to the base, the pitch box having a disconnect for controlling the supply of power to the condenser unit, and the pitch box having a threaded connector;
a line set penetrating through the rooftop into the channel, the line set extending through the opening in the at least one wall to the condenser unit for supplying a cooling circuit for the condenser unit;
a first electrical line penetrating through the rooftop into the channel, the first electrical line being directed into the pitch box and terminated to the disconnect; and
a second electrical line connected to the condenser unit and being housed within a liquid tight flexible conduit, the liquid tight flexible conduit being connected to the threaded connector on the pitch box, wherein the first and second electrical lines are connected to one another within the pitch box for supplying power to the condenser unit.

19. The system of claim 18, further comprising a ground-fault circuit interrupter outlet accessible from the exterior of the pitch box and a third electrical line penetrating through the rooftop into the channel and into the pitch box, wherein the third electrical line is connected to the ground fault circuit interrupter outlet.

20. The system of claim 18, wherein the disconnect defines a switch accessible from the exterior of the pitch box for switching between a power on state and a power off state.
